(19) United States
(12) Patent Application Publication
(10) Pub. No.: US 2025/0360997 A1
(43) Pub. Date: Nov. 27, 2025

(54) A SAIL BODY FOR FORMING PART OF A WIND ASSISTED PROPULSION DEVICE

(71) Applicant: ANEMOI MARINE TECHNOLOGIES LIMITED, London (GB)

(72) Inventors: Luke Neil MCEWEN, Lymington (GB); Nicholas CONTOPOULOS, Hullbridge (GB); Stephanie RYDER, London (GB)

(21) Appl. No.: 18/874,717

(22) PCT Filed: Jun. 13, 2023
(86) PCT No.: PCT/GB2023/051539

§ 371 Date: Dec. 13, 2024

(30) Foreign Application Priority Data
Jun. 14, 2022 (GB) 2208718.3

(51) Int. Cl. B63H 9/067; B29C 70/48; B29K 63/00; B29K 309/08; B29L 31/30; B32B 5/26

(52) U.S. Cl. CPC B63H 9/0678; B29C 70/48; B32B 5/26; B29K 2063/00; B29K 2309/08; B29L 2031/3067

(57) ABSTRACT

A method of manufacturing a sail body (3) for forming part of a wind assisted propulsion device (4), the method comprising the steps of: laying a first fabric (14), formed from first fibres, onto a mould (16) defining the shape of a part (2) of the sail body (3); laying a plurality of strips (22), formed from second fibres, onto a surface of the first fabric (14) such that at least some of the second fibres extend longitudinally along the sail body (3).

### FIELD OF THE INVENTION

This invention relates to a sail body for forming part of a device used in the wind assisted propulsion of objects, and particularly, but not exclusively, wind assisted propulsion of ships or vessels. The Invention also relates to a method of forming such a sail body, and to a vessel incorporating such a sail body.

Wind assisted propulsion devices such as rotor sails, wing sails and suction salls experience similar loads acting upon them when in use and therefore require similar characteristics.

From hereon, the invention will primarily be described with respect to rotor sails. However, this is for demonstrative purposes only and it is to be understood that this in no way limits the scope of the invention to rotor sails only,

### BACKGROUND

Rotor sails are also known as Flettner rotors. Known rotor sails typically comprise a cylindrical sleeve which forms the sail or sail body. This sleeve is adapted to spin on a static tower. Upper and lower bearings locate the rotor on the tower. Wind loads act on the sail body, typically seen as a reduction in air pressure on one side of the sail body, known as the suction side. The air pressure distribution has two main effects structurally:
Bending moment on the sail body as a whole (i.e., acting as a beam of circular hollow section subjected to a distributed load). This causes stresses in the plane of the sail skin, primarily tension and compression in the rotor axial direction due to the bending moment, with some in-plane shear caused by the accompanying shear force.
Local bending moments on the rotor skin tending to distort the circular cross section, because of the non-uniform distribution of air pressure around the section. This causes tensile and compressive stresses primarily in the circumferential direction around the sail body.

In the life of a rotor sail, major stresses on the sail body will fluctuate or even reverse with each revolution. The number of revolutions in the life of a rotor sail is very large, of the order of billions. This means that known sail bodies are made from a material that is resistant to fatigue failure. Laminated composite materials of continuous glass fibres or carbon fibres in a polymer resin are known to be suitable for this application.

In order to provide strength to the rotor, the fibres of the composite material used to make the sail body should be aligned with the principal stresses on the sleeve during use of the sail. This is because it is the fibres of the composite material that will provide the most strength to the sail body as a whole.

In known rotor sails, around 50% of the total strength will need to be longitudinal, in other words aligned with the sail axis, and around 30% of the total strength will need to come from approximately circumferentially/transversally orientated fibres, i.e., fibres which wrap around the sail axis.

The remaining material provides resistance to in-plane shear stresses although the in-plane shear stresses in a rotor sail are relatively small due to the inherent shear and torsional resistance of a large diameter tube of the type forming part of a rotor sail.

A further requirement is that the circumferentially/transversally orientated fibres should be as far as possible from the midplane or neutral axis of the laminate material forming the sail body. Such an arrangement will provide optimum bending strength in the circumferential/transversal direction. This helps to resist the local bending moments tending to distort the intended cross-section of the sail body.

Bending stiffness in the circumferential/transversal direction is also beneficial in order to resist buckling of the sail body.

The sail body is more liable to buckle in the circumferential/transversal direction than in the axial/longitudinal direction because cylinders, and similar shapes of other types of sail, are naturally more resistant to buckling axially due to the curvature of the surface of the cylinder.

A known method for forming composite materials is resin infusion, also known as VARTM (Vacuum Assisted Resin Transfer Moulding). This method is reasonably economical, with material costs driven down by the high-volume wind turbine blade industry.

A typical known rotor sail made using the resin infusion method will use a composite material having a sandwich construction with a foam core in the middle of the composite structure. The foam core will separate the outer layers to provide the required bending strength in the circumferential/transversal direction. Disadvantages of this method include the following:
The resin infusion method applies no tension to keep the fibres straight while the resin cures, meaning that the compressive strength of the material is lower, so more material is needed than would be the case if the fibres were held straighter.
Foam cores are relatively expensive both in material cost and labour and soak up a significant weight of resin which adds weight and further cost to the part.

With rotor sails, for example, the typical operating strains need to be kept to around 0.15% or less in both the axial and circumferential directions in order to achieve sufficient fatigue life.

There is therefore a need for an economical method of forming a composite material to form a wind assisted propulsion device which has the required axial/longitudinal and circumferential/transversal strength.

### SUMMARY OF THE INVENTION

According to a first aspect of the invention there is provided a method of manufacturing a sail body for forming part of a wind assisted propulsion device, the method comprising the steps of:
laying a first fabric, formed from first fibres, onto a mould defining the shape of a part of the sail body;
laying a plurality of strips, formed from second fibres, onto a surface of the first fabric such that at least some of the second fibres extend longitudinally along the sail body.

By virtue of comprising second fibres that extend longitudinally along the resultant sail body, the plurality of strips provides the axial/longitudinal strength required for wind assisted propulsion devices, especially rotor sails,

Meanwhile, the first fabric may comprise fibres that ultimately extend around the sail body to provide circumferential/transversal strength. Therefore, both circumferential and axial strength is provided to the sail body.

Accordingly, by means of embodiments of the invention, a sail body with suitable strength for use in a wind assisted propulsion device may be made at relatively low cost.

The mould may be a female mould, meaning that it is concave in shape, or a male mould, meaning that it is convex in shape. If it is a female mould, the strips are laid onto a concave surface of the first fabric. Conversely, if it is a male mould, the strips are laid onto a convex surface of the first fabric.

In embodiments of the invention, the method may comprise the further steps of:
introducing resin into the first fabric and, optionally, into and/or between the plurality of strips; and
heating the mould to cure the resin,

In such embodiments of the invention, the first fabric, plurality of strips and cured resin may form a sail body part for forming the sail body. It is therefore preferable, in such embodiments of the invention, for a female mould to be used so that the strips are positioned on the inner surface of the sail body and the outer surface can be smooth.

An advantage of forming one or more sail body parts in this way is that the quantity of strips can be varied along the length of the sail body (by adding more strips or spacing strips apart in different areas) to match variations in the bending moment, thereby minimising the total weight and cost of the axial material.

Also, more expensive carbon fibre strips of practical thickness can be used cost effectively instead of glass fibre because they can be spread apart rather than abutted in a continuous layer. Carbon fibre is advantageous because it is stronger and lighter and, in particular, carbon fibre has a better resistance to fatigue than glass fibre. The strength advantage of carbon fibre is especially significant when it is pultruded as the fibre straightness is beneficial. Thus, using carbon fibre in the axial/longitudinal direction of a sail body can be more cost effective than using glass fibre, even though carbon fibre material is more expensive per kg.

The introduction of resin may be carried out either before or after laying the plurality of strips over the first fabric. If resin is introduced before the plurality of strips are laid down, an additional step of bonding the strips to the first fabric with a structural adhesive would be required. Any suitable structural adhesive may be used.

Alternatively, if resin is introduced once the strips have already been laid onto the first fabric, the resin Itself may bond the strips to the fabric as it is cured.

However, particularly for rotor sails, a sail body formed from only a first fabric, a plurality of strips and cured resin will have an uneven inner surface that increases drag between the rotating sail body and the static tower, which increases the power consumption of the motor.

Accordingly, the method may comprise the further step of:
laying a second fabric, formed from third fibres, onto the plurality of strips.

This step may be carried out after introducing resin to the first fabric. However, it is preferable to lay the second fabric before any resin is introduced as this reduces the number of manufacturing steps required.

Accordingly, if a second fabric is added, the method may comprise the steps of:
introducing resin into the first and second fabrics and into and/or between the plurality of strips; and
heating the mould to cure the resin,
   wherein the first fabric, plurality of strips, second fabric and cured resin form a sail body part for forming the sail body.

In such embodiments of the invention, the first and second fabrics essentially sandwich the plurality of strips. The inclusion of the second fabric further improves the circumferential/transversal strength.

In embodiments of the invention, the method comprises the further step of forming the plurality of strips.

One or more of the plurality of strips may be formed using a pultrusion or pulwinding process.

Pultrusion processes are suitable for making straight tubes of circular or any other hollow or solid cross-section in a single operation. Pultrusion is a low-cost process because it is automated. Also, the raw materials are in their simplest form-Ilquid polymer resins and tows of glass or carbon fibre, which are used straight from a bobbin on which the tows are wound.

Tension is used to pull a profile through a dye to form a strip of material. This has the advantage of orientating the fibres axially along the strip, which maximises the compressive strength of the material. A strip formed from such a method may be referred to as a pultrusion.

Pulwinding is similar to pultrusion except that some of the fibres used to form a pulwound composite material are wound while they are being pulled through the die. This results in a material comprising some fibres that are straight, as in a pultruded material, and some fibres which are oriented at an angle to provide more strength in transversal directions. Although pulwound materials offer greater multi-directional strength, they are also more expensive than pultruded materials.

By using a pultrusion or pulwinding process, the sail body may be made particularly efficiently, since both pultrusion and pulwinding processes may be automated.

Using a pultrusion or pulwinding process means that the strips may be formed to have any desirable dimensions, and in some embodiments of the invention the strips have a thickness from about 1 mm to about 10 mm, or from about 1 mm to about 6 mm.

Both the first fabric and the pultrusions may be made to any desired length.

In embodiments of the invention, one or more of the plurality of strips may be formed so as to at least partially define a cavity within the sail body. In such embodiments of the invention, the strip itself may be hollow. Alternatively, the strip may have a cross-sectional shape defining a channel or groove. For example, the strip may have a U-shaped, V-shaped or W-shaped cross-section. Once laid onto the first fabric, the open side of the channel or groove may be closed by the first fabric. Alternatively, the open side could be closed by laying the second fabric over it.

Strips that at least partially define a cavity within the sail body have an increased thickness in a direction normal to the first fabric without weighing as much as an equivalently thick solld strip (i.e., a strip that results in no cavity being provided within the sail body).

If one or more cavities are provided within the sail body, the method may comprise the further step of making an aperture extending from a surface of the sail body part to the cavity. This allows the cavity to be used as a channel for transporting air from outside of the sail body to a suction mechanism inside the wind assisted propulsion device, The wind assisted propulsion device would therefore be operable as a suction sail.

In embodiments of the invention, one or more of the plurality of strips is formed so that at least one end comprises a taper, preferably wherein the taper comprises a concave surface. In other words, the thickness of one or more strips may be tapered towards one or both ends of the strip(s).

In embodiments of the invention, each strip of the plurality of strips may comprise a pair of profiled edges, each profiled edge shaped to nest or interlock with a profiled edge of an adjacent strip. The step of laying the plurality of strips onto the surface of the first fabric may therefore comprise nestling, or interlocking, a profiled edge of one or more of the plurality of strips against, or into engagement, with a profiled edge of an adjacent strip.

The profiled edges may also allow for easier positioning of the strips onto the first fabric because each strip may act to hold its adjacent strips in place.

As an alternate way of keeping the strips in place, or as an additional measure, the step of laying the plurality of strips onto the surface of the first fabric may comprise attaching the plurality of strips to the surface of the first fabric.

Attaching the plurality of strips to the surface of the first fabric may comprise at least one of:
pre-bonding the strips to a backing scrim;
using one or more rigid or flexible jigs to hold the plurality of strips against the first fabric; and
weaving fibres or light cloth tape between the strips.

In embodiments of the invention, the step of laying the plurality of strips may comprise laying the plurality of strips such that an average width of an area of the first fabric not covered by any strip (which may be referred to as an uncovered area) is less than 30% of a total width of the first fabric, each width of an uncovered area being measured normal to the strips and the average width of an uncovered area being dependent on all areas of the first fabric not covered by any strip.

It is to be understood that the total width of the first fabric is defined by the shape of the first fabric when laid onto the mould. This remains true even if the first fabric is provided in sheets which may have a width that is different to the width of first fabric laid on the mould defining the shape of a part of the sail body. In other words, the total width of the first fabric is not necessarily the same as the width of a sheet of the first fabric that might be provided for laying onto the mould.

The average width of an area of the first fabric not covered by any strip may be calculated by summing the total width of all areas of the first fabric not covered by any strip and dividing that sum by the number of areas of the first fabric not covered by any strip.

Similarly, the step of laying the plurality of strips may comprise laying the strips so as to cover greater than 30% of the surface area of the first fabric, optionally greater than 40%, preferably greater than 50% and more preferably greater than 60%.

In embodiments of the invention, the plurality of strips may form a first layer of strips and the method may comprise the further step of:
laying one or more additional pluralities of strips onto at least part of the first layer of strips, or the second fabric, to form one or more auxillary layers of strips.

In other words, the sail body part is formed to comprise two or more layers of strips in at least a portion of the sail body part. Such additional layers of strips may reinforce that portion of the resulting sail body part, particularly in the axial/longitudinal direction.

The strips of each additional layer may be thinner or thicker than the strips of the first layer, depending on the level of additional reinforcement needed.

Such embodiments of the invention may comprise the further step of:
laying an intermediary fabric onto at least part of a laid layer of strips prior to laying an additional layer of strips onto said at least part of the laid layer of strips.

This can be advantageous as it can help the resin to penetrate and fill all the gaps between the strips.

In order to form a complete sail body, two or more sail body parts may be joined together.

The method may also comprise the further step of attaching one or more circumferential ribs to an inner surface of one or more sail body parts, either before or after joining sail body parts together to form the sail body. The circumferential ribs may further reinforce the sail body.

In embodiments of the invention the wind assisted propulsion device may be a wind assisted ship/vessel propulsion device and may, preferably, be one of a rotor sail; a wing sail; and a suction sail.

In embodiments in which the wind assisted propulsion device is a rotor sail, the sail body may be a rotor sail body and the mould may comprise a substantially semi-cylindrical surface.

According to a second aspect of the invention there is provided a sail body for forming part of a wind assisted propulsion device, the sail body comprising a plurality of sail body parts joined together to form the sail body, each sail body part comprising:
a first skin formed from a first fibrous material formed from first fibres; and,
a plurality of strips extending longitudinally along the sail body,
   wherein each strip is formed from a second fibrous material formed from second fibres, at least some of which second fibres extend longitudinally along the sail body.

The features and advantages of the first aspect of the invention, and its embodiments, apply mutatis mutandis to the second aspect of the invention and its embodiments.

The first fibrous material may comprise a first fabric and cured resin formed according to embodiments of the first aspect of the invention.

In some embodiments of the invention each sail body part may further comprise a second skin formed from a third fibrous material formed from third fibres, wherein the plurality of strips is positioned between the first and second skins. The third fibrous material may comprise a second fabric and cured resin formed according to embodiments of the first aspect of the invention.

In embodiments of the invention, the second fibres may be glass fibres and/or carbon fibres.

One or more of the plurality of strips may:
be a strip of pultruded or pulwound material;
have a thickness from about from about 1 mm to about 10 mm, or about 1 mm to about 6 mm; and/or
have a thickness, in a direction normal to the first skin, at least double the thickness of the first skin, preferably at least three times the thickness of the first skin, more preferably at least four times the thickness of the first skin.

In embodiments of the invention, one or more of the plurality of strips may define a cavity within the sail body. In such embodiments of the invention, the sail body may comprise one or more apertures extending from a surface of the sail body part to the cavity.

In embodiments of the invention, one or more of the plurality of strips has a cross-sectional shape that is curved to follow approximately the shape of the sail body, substantially rectangular or substantially trapezoidal.

Substantially rectangular shaped strips may be cheaper to manufacture by virtue of their simplicity. However, the rectangular shape may prevent the strips from fitting optimally alongside one another and next to the skin (or skins) of the sail body part due to the curved shape of the sail body part.

Accordingly, strips with a substantially trapezoidal shapes may be preferable because the gaps between adjacent strips and between the strips and skin(s) may be reduced. This means that less resin is required to fill the gaps, thereby reducing the weight of the sail body part and reducing material costs.

Strips with a cross-sectional shape that is curved to follow approximately the shape of the sail body may be even more preferable as the size of gaps may be reduced even further.

Additionally, or alternatively, each strip of the plurality of strips comprises a pair of profiled edges, each profiled edge shaped to nest or interlock with a profiled edge of an adjacent strip. The profiled edges may also reduce the size of gaps between strips that are alongside or interlocked with one another, thereby similarly reducing the amount of resin required to fill those gaps and hence reducing the weight of the resulting sail body as well as reducing material costs.

The profiled edges may also improve the ease of manufacturing the sail body part, as described above with respect to embodiments of the first aspect of the invention,

In embodiments of the invention, one or more of the plurality of strips may comprise at least one end comprising a taper, preferably wherein the taper comprises a concave surface.

The taper reduces stress concentrations in the strips and, particularly, in the resin between the strips. A concave surface to the taper may provide even further reduction in stress concentration.

In embodiments of the invention, a sail body part may be configured such that an average width of any area of the sail body part not comprising a strip in a direction normal to the first skin is less than 30% of the total width of the first skin, measured normal to the strips.

Similarly, in some embodiments of the invention, the sail body part may be configured such that strips cover greater than 30% of the surface area of the first skin, optionally greater than 40%, preferably greater than 50% and more preferably greater than 60%.

In embodiments of the invention, the first skin and/or the second skin may have a thickness from about 1 mm to about 4 mm. Also, the first fibres and/or third fibres may be glass fibres.

The sail body may be considered as having a sail axis extending longitudinally through the sail body. In embodiments of the invention, the first fibres and/or the third fibres may be oriented at more than 45 degrees, and preferably more than 55 degrees, to the sail axis.

The number of strips may vary along and/or around the sail body.

According to a third aspect of the invention there is provided a sail body according to embodiments of the second aspect of the invention, formed using a method according to embodiments of the first aspect of the invention.

The features and advantages of the first and second aspects of the invention, and their embodiments, apply mutatis mutandis to the third aspect of the invention and its embodiments.

According to a fourth aspect of the invention there is provided a vessel comprising a wind assisted propulsion device attached to a portion of the vessel, which wind assisted propulsion device comprises a sail body according to embodiments of the second or third aspects of the invention.

The features and advantages of the aforementioned aspects of the invention, and their embodiments, apply mutatis mutandis to the fourth aspect of the invention and its embodiments.

### BRIEF DESCRIPTION OF THE DRAWINGS

The invention will now be described by way of example only with reference to the accompanying drawings in which:

FIG. 1 is a schematic representation of a rotor sail comprising a sail body according to an embodiment of the second aspect of the invention;

FIG. 2 is a schematic representation of a first fabric laid on a mould according to an embodiment of the first aspect of the invention;

FIG. 3 is a schematic representation of a plurality of strips laid on a first fabric according to an embodiment of the first aspect of the invention;

FIG. 4 is a schematic representation of a plurality of strips bonded to a backing scrim according to an embodiment of the first aspect of the invention;

FIG. 5 is a schematic representation of a second fabric laid on a plurality of strips according to an embodiment of the first aspect of the invention;

FIG. 6 is a schematic representation of a sail body part formed by the method shown in FIG. 5;

FIGS. 7 to 10 are schematic representations of sail body parts, according to embodiments of the second aspect of the invention, comprising solid strips;

FIGS. 11 to 13 are schematic representations of sail body parts, according to embodiments of the second aspect of the invention, comprising hollow strips;

FIG. 14 is a schematic representation of a sail body part, according to an embodiment of the second aspect of the invention, comprising a second layer of strips;

FIG. 15 is a schematic representation of a sail body part, according to an embodiment of the second aspect of the invention, comprising spaced strips;

FIGS. 16 to 18 are schematic representations of means for joining two sail body parts side-by-side to extend around the sail axis; and

FIG. 19 is a schematic representation of means for joining two sail body parts end-to-end to extend along the sail axis.

### DETAILED DESCRIPTION

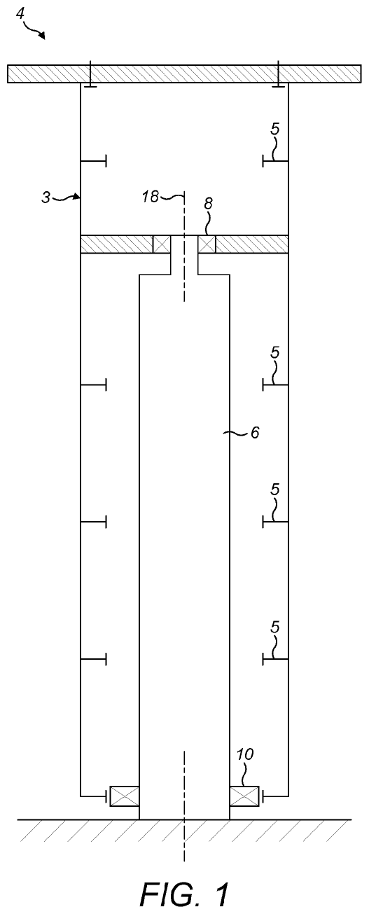

Referring now to FIG. 1, an example of a wind assisted propulsion device, which may be formed according to embodiments of the first aspect of the invention, is shown, More specifically, a rotor sail, or Flettner rotor, is shown wherein the rotor sail is defined generally by the reference numeral 4. The rotor sail 4 comprises a sail body 3 rotatably mounted to a static tower 6 via upper bearings 8 and lower bearings 10 such that it is rotatable about a sail axis 18. The sail body 3 comprises a plurality of circumferential ribs 5 which reinforce the sail body 3 to provide circumferential bending strength and stiffness. In this example the circumferential ribs 5 are attached to the inside of the sail body 3, although circumferential ribs may also be attached to the outside of a sail body.

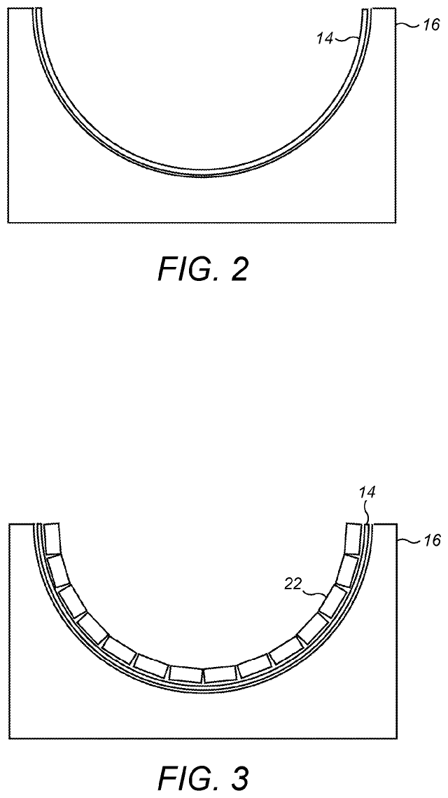

FIGS. 2, 3 and 5 illustrate stages of a method for forming part of a sail body such as the sail body 3 shown in FIG. 1. However, it is to be understood that the method is equally suitable for forming part of a sail body to be used in other wind assisted propulsion devices such as wing sails or suction sails.

In particular, FIG. 2 shows a first fabric 14, formed from first fibres, laid on a mould 16.

In this embodiment of the invention, the mould 16 is a female mould, meaning that it is concave in shape. The mould 16 also defines a shape of part of the sail body 3.

More specifically, the mould 16 defines a substantially semi-cylindrical shape to allow the formation of a substantially semi-cylindrical sail body part which may be joined with another substantially semi-cylindrical sail body part to form the substantially cylindrical sail body 3.

The first fibres may be any suitable material such as carbon, aramid, basalt, E-glass, S-glass or ECR-glass for example.

The orientation of the first fibres relative to the sail axis 18 is determined by the orientation at which the first fibres are weaved into the first fabric 14 and also the orientation at which the first fabric is laid onto the mould 16 relative to the sail axis 18. At least some of the first fibres may be oriented at more than 45 degrees, and preferably more than 55 degrees, to the sail axis 18. For example, the first fibres may have orientations of ±45 and 90 degrees to the sail axis 18; 0, ±45 and 90 degrees to the sail axis 18; or ±60 degrees to the sail axis 18.

To form a sail body for a rotor sail of 4 m to 5 m diameter and 25 m to 35 m height, the first fabric 14 may, for example, be a 1 mm to 4 mm thick E-glass-/epoxy-based fabric. Such fabric is typically provided in sheets around 1.2 m to 1.5 m wide so can be laid in bands along or across the mould 16. Adjacent bands of fabric may overlap 30 mm to 100 mm for structural continuity across the sail body part.

FIG. 3 shows a plurality of strips 22 laid on the first fabric 14. The strips 22 are formed from second fibres and are positioned on the first fabric 14 such that at least some of the second fibres extend longitudinally along the first fabric 14, i.e., longitudinally along the sail resultant sail body 3. The second fibres may be any suitable material such as carbon, aramid, basalt, E-glass, S-glass or ECR-glass for example. Each strip 22 may be formed using a pultrusion or pulwinding process,

To form a sail body for a rotor sail of 4 m to 5 m diameter and 25 m to 35 m height, each of the plurality of strips may, for example, be 1 mm to 6 mm thick (In a direction normal to the first fabric).

In order to ensure that the plurality of strips 22 remain in the desired position until they are fixed to the first fabric 14 during a later stage of the method, an attaching means may be used to attach the plurality of strips to the surface of the first fabric 14. This may particularly be necessary to prevent the upper strips 22 (on the near-vertical sides of the female mould) from falling down into the mould 16.

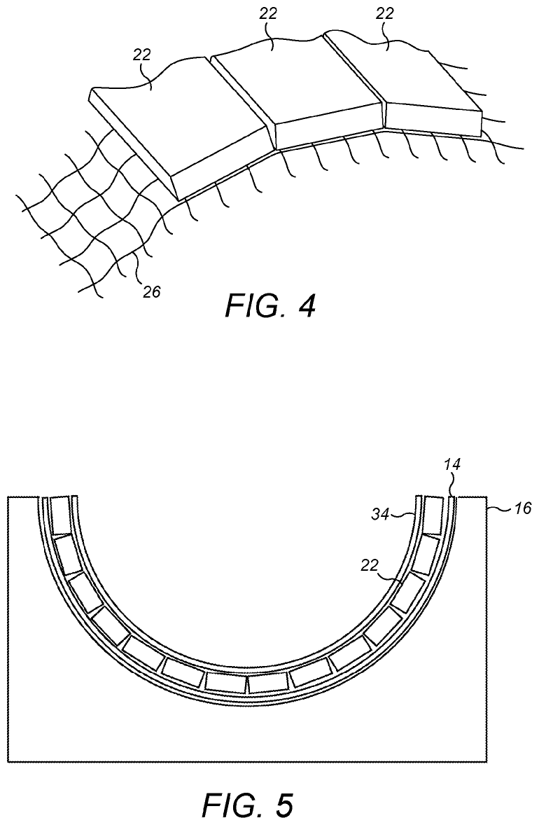

In this embodiment of the invention the strips are pre-bonded to a backing scrim 26 as shown in FIG. 4. The plurality of strips 22 may therefore be attached to the first fabric 14 as a single assembly rather than as individual strips. This is analogous to mosaic tiles for bathrooms and kitchens, for example, which are mounted to a backing layer so that the tiles can be applied to a wall in large sheets rather than individual tiles.

Using a backing scrim 26 may simplify the attachment of strips 22 to the first fabric 14, especially if a male mould is used as it would prevent the strips from falling off the sides of the mould. However, the process of pre-bonding the strips 22 to the backing scrim 26 requires an additional process step.

In other embodiments of the invention, the strips 22 may be held in place on the first fabric 14 with rigid or flexible jigs which are adapted to ensure desired spacing of the strips over the first fabric 14. In further embodiments of the invention, fibres of light cloth tape may be weaved between the strips to keep them in place on the first fabric 14.

In FIG. 5, a second fabric 34, formed of third fibres, is laid on the plurality of strips 22.

Similarly to the first fibres, the third fibres may be any suitable material such as carbon, aramid, basalt, E-glass, S-glass or ECR-glass for example. To form a sail body for a rotor sail of 4 m to 5 m diameter and 25 m to 35 m height, the second fabric 34 may be a 1 mm to 4 mm thick E-glass-/epoxy-based fabric, similarly to the first fabric 14.

The third fibres may also be oriented similarly to the first fibres.

In some embodiments of the invention, it may be beneficial to incorporate axial/longitudinal fibres, oriented at about 0 degrees to the sail axis, into one or both of the first and second fabrics 14, 34. Preferably, such fibres are incorporated into the second fabric 34 as this prevents the fibres from causing distortion of the paths of the strips 22 in the mould. The axial/longitudinal fibres can be incorporated as unidirectional material or, if there are also elevated stresses in the other directions, as a multiaxial material such as 0/45/90/−45 quadriaxial.

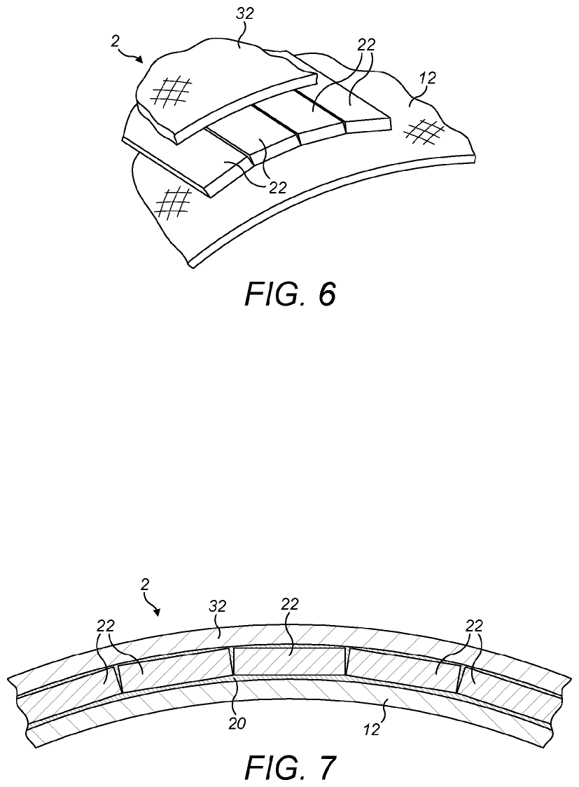

The first fabric 14, plurality of strips 22 and second fabric 34 form a laminate structure shown more clearly in FIG. 6. To fix these components together, resin is introduced into the laminate structure while in position on the mould 16 and then the mould 16 is heated to cure the resin.

One suitable method of introducing the resin is by an infusion process. However, other suitable processes for introducing the resin may also be used.

In order to carry out a resin infusion process, a sealing means, which may include a vacuum bag and other consumables, is laid on top of the first fabric 14, plurality of strips 22 and second fabric 34 while in place on the mould 16 and sealed around the edges. Air is then sucked from the sealed laminate structure and then the resin is infused into it. Once the resin has been cured, some or all of the sealing means may be removed to provide a sail body part that can then be removed from the mould 16.

The resin may be any suitable type of resin, such as epoxy resin, vinylester resin, polyester resin, polyurethane resin or acrylic resin, for example. Resins may be thermoset or thermoplastic and may be cured at ambient temperature or at elevated temperature to suit the required speed of the process and the eventual strength and temperature resistance required of a rotor body in use forming part of a rotor sail. For example, the resin may be an epoxy resin. The resin and any adhesive used in the manufacture of the sail body 3 may then be further cured (post-cured) by elevating the temperature of the complete rotor body to increase the degree of cure of the resin and further improve its strength and temperature resistance.

A benefit of using a female mould is that the surface of the sail body part 2 which eventually forms the outer surface of the sail body 3 is in contact with the surface of the mould during the manufacturing process. The surface of the mould 16 may be smooth and, therefore the cured resin forming the outer surface of the sail body will mirror the smoothness of the mould 16. Accordingly, by using a female mould, a sail body 3 may be formed with a smooth surface that may improve the performance of the wind propulsion device.

Referring now to FIG. 7, a sail body part 2, which may have been formed using the method described above, is shown in cross-section. The sail body part 2 comprises a first skin 12, a plurality of strips 22 and a second skin 32 with resin 20 bonding the skins and strips together. The first skin 12 is formed from a first fibrous material formed from first fibres, e.g., the first fabric 14 (shown in FIGS. 2, 3, 5 and 6) with resin infused therein. Similarly, the second skin 32 is formed from a third fibrous material formed from third strips, e.g., the second fabric 34 (shown in FIGS. 5 and 6) with resin infused therein.

In this embodiment of the invention, each strip 22 is a strip of pultruded material, which is a strip of material formed by way of a pultrusion process.

In other embodiments of the invention, each strip may be a strip of pulwound material, which is a strip of material formed by way of a pulwinding process.

In further embodiments of the Invention, other suitable types of fibrous material may be used.

Each strip 22 is substantially rectangular in cross-sectional shape with edges abutting against the edges of adjacent strips 22. Resin 20 fills any gaps between adjacent strips 22 and between the first skin 12, plurality of strips 22 and second skin 32 and acts to bond the first skin 12, plurality of strips 22 and second skin 32 together.

The first and second skins 12, 32 each comprise first and third fibres orientated at more than 45 degrees to the sail axis. The orientation of the first and third fibres provides the sail body part 2 with strength in a circumferential/hoop direction, normal to the sail axis, so that a sail body comprising one or more of the sail body parts 2 may maintain its intended cross-sectional shape when in use forming part of a wind assisted propulsion device. Meanwhile, the strips 22 comprising second fibres, at least some of which are orientated parallel to the sail axis, provide the sail body part 2 with strength In the axial direction, parallel to the sail axis so that, in use, the sail body comprising the sail body part 2 may withstand bending forces caused by pressure from the wind.

Although the resin 20 bonds the various components of the sail body together, reducing the amount of resin used may advantageously reduce material costs and the resultant weight of the sail body. It may therefore be preferable to avoid using resin in excess of that which is needed for bonding the layers of the sail body part together.

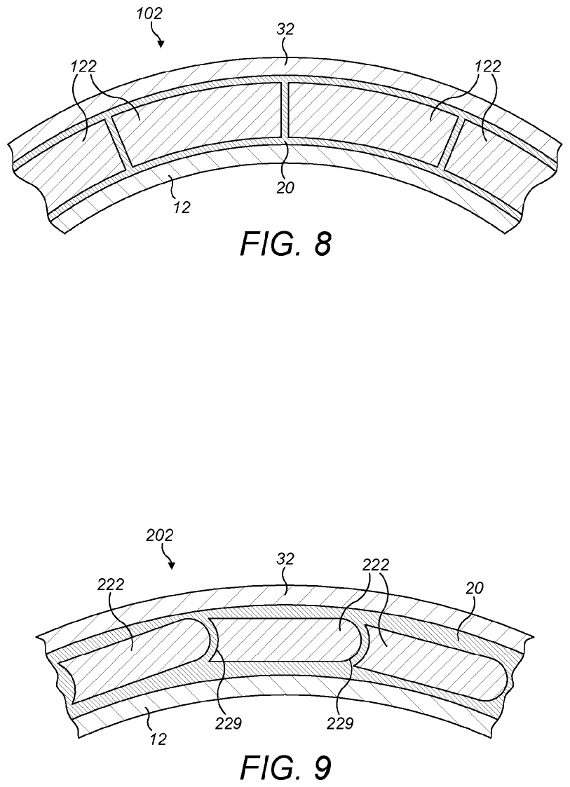

Accordingly, FIG. 8 shows a sail body part 102 similar to the sail body part 2 shown in FIG. 7 except that each of a plurality of strips 122 is arcuate in cross-sectional shape so that the strips 122 may fit more closely to the first and second skins 12, 32. Also, the edges of the strips 122 are angled so that each strip 122 may fit more closely to the adjacent strips 122. The spaces between adjacent strips 122 and between the first skin 12, plurality of strips 122 and second skin 32 are therefore reduced in comparison to the sail body part 2 shown in FIG. 7. Accordingly, less resin 20 may be required to fill the spaces and bond the components of the sail body part together.

The sail body part 102 may therefore be manufactured with lower material cost and with a lower weight.

The strips may also be shaped to improve the ease with which they are laid onto the first fabric 14 and held there during the formation of the sail body part. For example, FIG. 9 shows a sail body part 202, which may form part of a sail body according to another embodiment of the second aspect of the invention, comprising a plurality of strips 222. Each strip 222 has profiled edges 229 shaped to nest against the profiled edges 229 of adjacent strips 222. Each strip 222 thereby encourages its adjacent strips 222 to stay in position which may reduce the burden on manufacturers to hold the strips 222 in place.

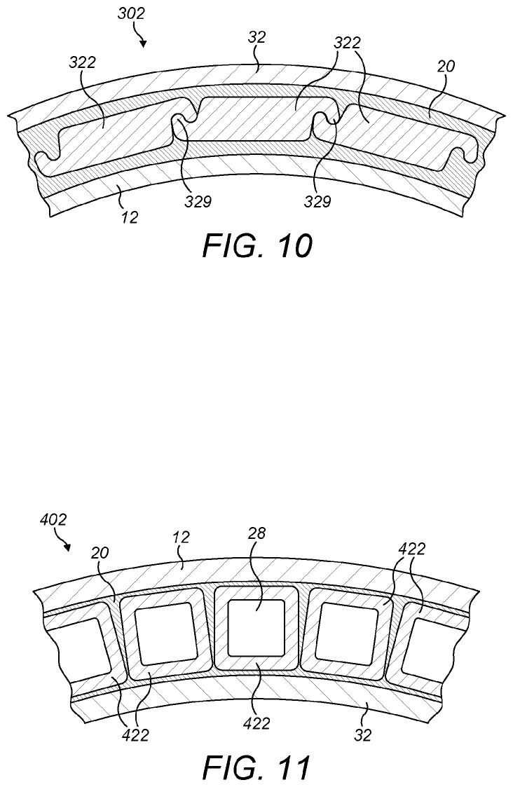

Similarly, in FIG. 10 a sail body part 302 is shown that comprises a plurality of strips 322 comprising profiled edges 329 that interlock with the profiled edges 329 of adjacent strips 322.

Despite the improved circumferential bending strength provided by a layer of strips between the skins, it is typically necessary to reinforce the sail body with circumferential ribs (such as the circumferential ribs 5 shown in FIG. 1) to provide the necessary circumferential bending strength and stiffness. In some embodiments of the invention, those ribs can be attached on the inside of sail body at spacings of around 0.5 to 1.5 times the diameter or chord of the sail. Hence, for a typical rotor sail, between 3 and 15 ribs may be optimal, spaced along the length of the sail body.

Referring now to FIG. 11, a sail body part 402, which may form part of a sail body according to another embodiment of the second aspect of the invention, comprises a plurality of strips 422. The sail body part 402 is similar to the sail body part 2 shown in FIG. 7 except that each strip 422 is a hollow strip comprising a cavity 28.

Due to the cavity in each strip, the strips may be formed with a greater cross-sectional area despite using the same quantity of material and, hence, having the same weight. The first and second skins 12, 32 may therefore be spaced further apart in sail body part 802 compared to the skins of sail body part 2 shown in FIG. 7. The increased spacing of the first and second skins 12, 32 may increase the circumferential bending strength and stiffness of the sail body part 802 without adding the parasitic cost or weight of a foam core nor increasing the material cost or weight of the strips. With this increased bending strength and stiffness, the need for circumferential ribs can be reduced or avoided.

During manufacture of the sail body part 402, particularly in advance of the introduction of resin, it may be necessary to prevent resin from being able to fill the cavities. This may be done by any suitable means, such as by plugging the open ends of the strips 422.

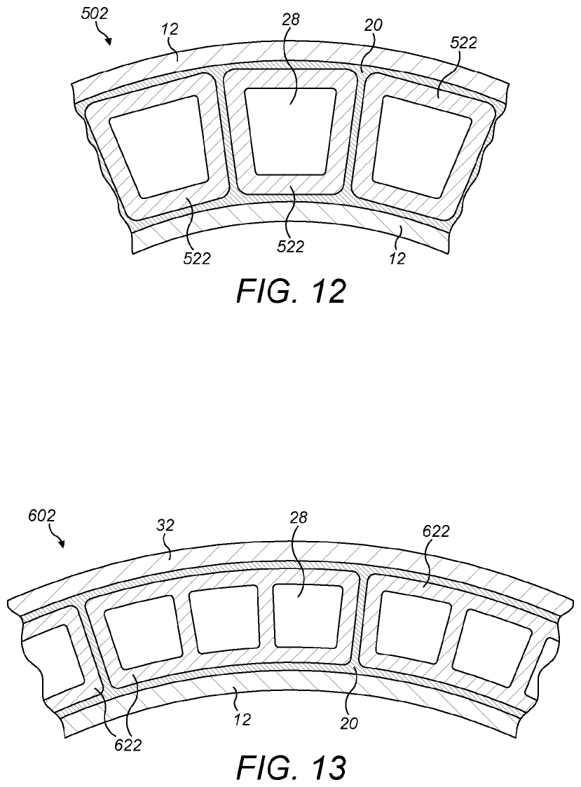

In FIG. 12, a sail body part 502 is similar to the rotor tube 402 except that It comprises a plurality of strips 522 which are trapezoidal in cross section. In other words, the edges of the strips 522 which abut against the edges of other strips 522 are angled so that the spacing between strips 522 may be reduced and the amount of resin 20 required to fill the spaces is also reduced.

In FIG. 13, a sail body part 602 is similar to the sail body parts 402 and 502 shown in FIGS. 11 and 12 except that each strip 622 is wider and comprises a plurality of cavities 28. This further Increases the efficiency of material required to form the strips 622 without sacrificing the shear strength of the strips 622. Each strip 622 may be formed with angled edges similarly to the strips 522 shown in FIG. 12 and may further be formed with an arcuate cross-section similarly to the strips 122 shown in FIG. 8, thereby reducing spacing present in the sail body part 602 and reducing the amount of resin 20 required.

Suction sails may be similar to rotor sails and wing sails except that they additionally comprise means for controlling flow of the boundary layer of air over the surface of the sail body, preferably by producing a substantial pressure reduction or vacuum at the surface of the body (for example, by suction or aspiration through a fluid-permeable region of the surface). This enables the creation of high drive forces for a particularly low expenditure of energy.

In embodiments of the invention, the cavities present in the sail body, such as those shown in FIGS. 11 to 13, may be used as channels for transporting air from outside of the sail body to a suction mechanism inside the wind assisted propulsion device, This may be achieved by making one or more apertures that extend from a surface of the sail body part 402, 502, 602 to a cavity 28.

In some embodiments of the invention, such as those described with respect to FIGS. 7 to 13, the strips are laid in a single layer along most or all the length of the sail body part. However, in use, there are areas where the bending moment on the sail body (hence the load in one or both skins in the axial/longitudinal direction) is higher than in other areas, For example, in rotor sails 4 (such as that shown in FIG. 1), highly loaded areas typically include the skins near to the upper bearing 8 (FIG. 1), as the region of the rotor sail 4 above this point acts as a cantilever. In these areas it is beneficial to reinforce the rotor locally, rather than reinforcing the rotor over its whole length.

Such local reinforcement can be achieved by adding more strips in a second layer. In FIG. 18, a sail body part 702 is similar to the sail body part 2 shown in FIG. 7 except that it comprises a plurality of strips 722b included in a second layer that extends along a part of the length of the sail body part 702. This is in addition to a plurality of strips 722a provided as a first layer along the length of the sail body part 702.

To reduce stress concentrations in the strips and, particularly, in the resin between the strips, it is beneficial for one or both ends of the strip to comprise a taper 724. In other words, the thickness of each strip 722b is tapered towards each end of the strip 722b. Even more beneficially, that taper 724 is concave rather than linear as this results in an even lower stress concentration.

Although the end of the strips 722a in the first layer cannot be seen, each end of those strips may also comprise a taper 724. Similarly, each of the strips shown in FIGS. 7 to 13 may comprise a taper at one or both ends of the strip.

During manufacture of a sail body part comprising two or more layers of strips, such as sail body part 702, it can be advantageous to place a layer of an intermediary fabric 25 between the layers of strips 722a, 722b to help the resin to penetrate and fill all the gaps between the strips. Such intermediary fabric 25 can be a woven, stitched or non-woven (felt/veil) fabric.

Alternatively, the introduction of resin can be conducted in more than one step. For example, resin may first be introduced to first fabric and first layer of strips, then a second layer of strips and the second fabric can be added, and an additional amount of resin can be introduced. However, this would require more time and vacuum consumables.

Referring now to FIG. 15, a sail body part 802 which may form part of a rotor body according to another embodiment of the second aspect of the invention is shown. The rotor tube 802 comprises a first skin 12 and no second skin.

In this embodiment of the Invention, the first skin 12 may be made according to the method described above wherein the first fabric 14 alone is infused with resin. A plurality of strips 822 are added afterwards, onto the internal surface of the first skin 12. The strips 822 are bonded in place with a structural adhesive 821.

Advantageously, the quantity of axial material can be more easily varied along the length of the sail body (by adding more strips locally) to match variations in the bending moment, thereby minimising the total weight and cost of the axial material.

Also, more expensive carbon fibre strips of practical thickness can be used cost effectively instead of glass fibre because they can be spread apart rather than abutted in a continuous layer. In a continuous layer, only around 1-2 mm thickness of carbon fibre is required on a 5 m diameter rotor body, which means previously described embodiments of the invention would barely benefit from having pultruded or pulwound strips to separate the first and second skins for good bending strength. In this embodiment of the invention, narrower strips can be used, for example, with dimensions of 50 mm width, 5 mm thickness, and with 150 mm gaps in between, Carbon fibre is advantageous because it is stronger and lighter and, in particular, carbon fibre has a better resistance to fatigue than glass fibre. The strength advantage of carbon fibre is especially significant when it is pultruded as the fibre straightness is beneficial. Thus, using carbon fibre in the axial direction of a sail body according to embodiments of the invention can be more cost effective than using glass fibre, even though carbon fibre material is more expensive per kg.

In the sail body 802, each strip 822 is an I-beam shaped pultrusion (strip of pultruded material) with significant depth in the direction normal to the first skin 12. Such strips can be used without weight penalty (compared to a continuous layer of adjacent pultrusions) because they can be spread apart as shown in FIG. 15. Deep pultrusions provide substantially greater flexural stiffness in the axial direction, hence resistance to buckling of the shell, particularly when supported by circumferential ribs placed at intervals along the length of the sail. Hollow strips such as those shown in FIGS. 11 to 13 may be similarly beneficial. However, the strips may also have a simpler shape such as those shown in FIGS. 7 and 8.

Since the strips are not positioned in the middle of two skins, the required thickness of the first skin 12 may need to be made up using more first fibre so that sufficient circumferential bending strength is provided. In other words, the first fabric 14 must be thicker. Further, a second step of bonding the pultrusions to the first skin 12 is necessary and a large amount of adhesive 21 is required which adds cost and weight.

Also, particularly for rotor sails, there exists aerodynamic drag between the sail body 3 and the tower/static cylinder 6 (see FIG. 1) which increases the power consumption of the motor. If embodiments of the invention are used which have no second (inner) skin, this drag is exacerbated by the uneven inner surface of the sail body caused by the strips.

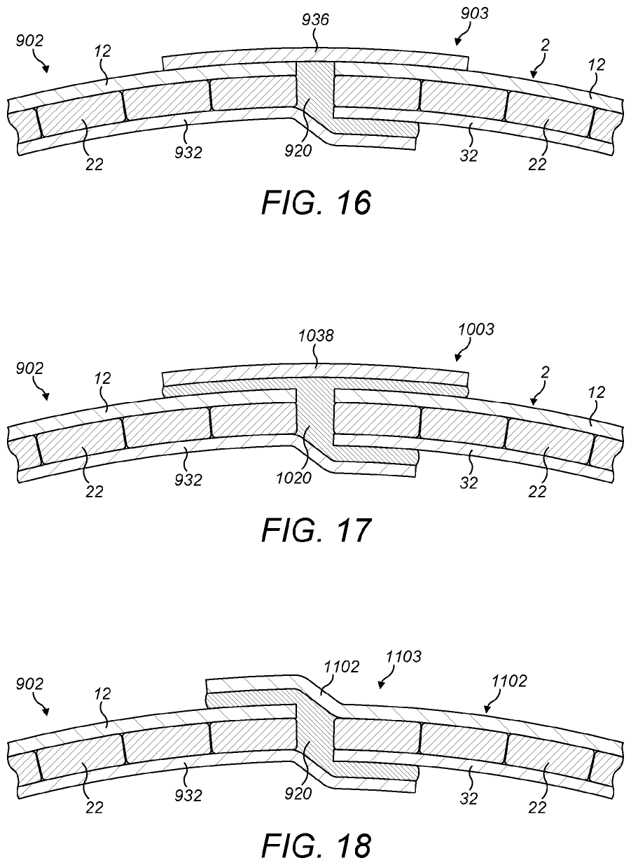

Referring now to FIGS. 16 to 18, means of joining two sail body parts side-by-side, so as to extend further around the sail axis, is shown.

In FIG. 16, a sail body part 2 (such as that shown in FIG. 2) is joined to a sail body part 902 which is similar to the sail body part 2 except that it comprises an extended inner skin 932. To join the two sail body parts 2, 902, they are positioned to abut against one another so that the curved shape of each sail body part aligns with the curved shape of the other part. A joint fabric 936 is then laid over the exposed edges of the two sail body parts 2, 902. Resin 920 may be introduced into the joint fabric 936 and any gaps between the two sail body parts 2, 902 either while the parts are being positioned together or once they have been correctly positioned. The resin 920 is then cured, thereby fixing the two sail body parts 2, 902 together to form a sail body 903.

The resin 920 may be the same resin used in the formation of the sail body parts 2, 902 or may be a different resin. For example, the resin 920 may have a higher viscosity than the resin used in the formation of the sail body parts 2, 902 so that it broadly holds its shape when being introduced to the sail body parts 2, 902, therefore making it easier to position the respective parts.

FIG. 17 shows a sail body 1003 which is similar to the sail body 903 shown in FIG. 16 except that a joint skin 1038 is used to cover the exposed edges of the two sail body parts 2, 902. The joint skin 1038 differs from the joint fabric 936, shown in FIG. 16, in that it has already had resin introduced into the fabric and cured. Accordingly, rather than curing the resin in a joint fabric in order fix it to the two sail body parts 2, 902, the joint skin 1038 is bonded to the two parts with a bonding resin 1020.

In FIG. 18, rather than adding an additional joint fabric or skin, both sail body parts comprise an extended skin. In particular, a sail body 1103 is shown which comprises a sail body part 902 (as in FIGS. 16 and 17) and a sail body part 1102 which comprises an extended first skin 1112. Accordingly, the extended first skin 1112 overlaps the exposed edges of the two sail body parts 902, 1102 in one direction while the extended second skin 932 overlaps the exposed edges of the two sail body parts 902, 1102 in the opposite direction.

In other embodiments of the invention, an extended skin forming part of one sail body part may be accommodated by a recess in the other sail body part so that the convex surface of the finished sail body is smooth. For example, the extended first skin 1112 may be accommodated in a recess (not shown) in the sail body part 902.

The three options shown in FIGS. 16 to 18 can also be inversed. For example, the joint fabric 936 could be used to cover the concave surfaces rather than the convex surfaces.

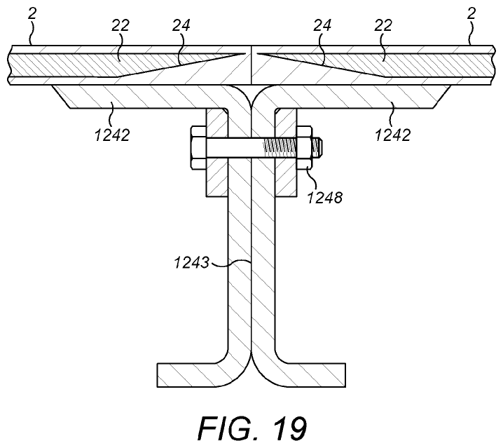

Referring now to FIG. 19, a means of joining two sail body parts end-to-end, so as to extend further in the longitudinal direction, is shown. This joining means may be applied to any of the sail body parts shown in FIGS. 7 to 18, although sail body parts 2 (as shown in FIG. 7) are used as an example. A joining piece 1242 is bonded to each of the sail body parts 2 to be joined using adhesive (not shown). Each joining piece 1242 comprises a normal surface 1243 adapted to abut against the normal surface 1243 of the other joining piece 1242. The two joining pieces 1242 are then bolted together using a bolt assembly 1248.

In other embodiments of the invention each joining piece 1242 may be integrally formed with the respective sail body part 2.

An advantage of this joining means is that it permits disassembly of a sail body for transport and can be adapted to Incorporate circumferential ribs such as the circumferential ribs 5 shown in FIG. 1.

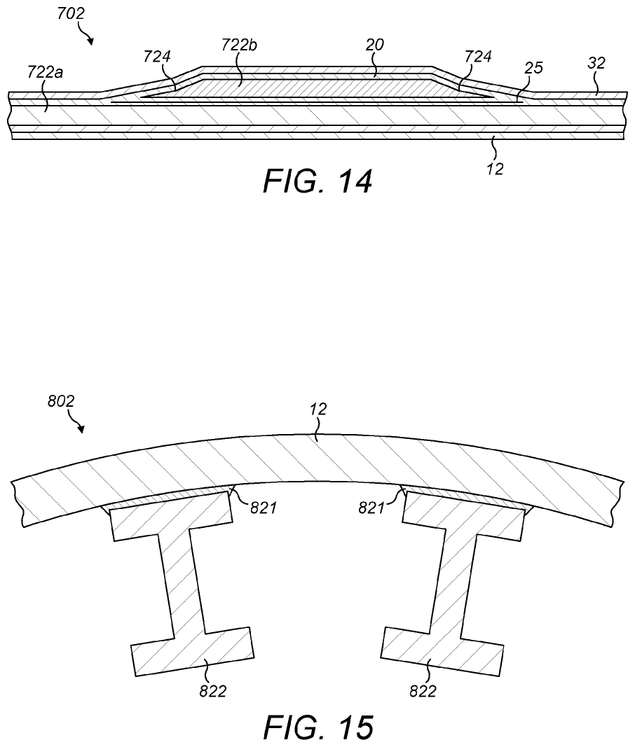

Unlike FIG. 7, ends of the sail body parts 2 are visible in in FIG. 19. Accordingly, it may be seen that the ends of the strips comprise a taper 24 similar to the tapers 724 described with respect to FIG. 14. As mentioned above, the tapers reduce stress concentrations in the strips 22.

Preferences and options for a given aspect, feature or parameter of the invention should, unless the context indicates otherwise, be regarded as having been disclosed in combination with any and all preferences and options for all other aspects, features and parameters of the invention.

1. A method of manufacturing a sail body for forming part of a wind assisted propulsion device, the method comprising the steps of:
laying a first fabric, formed from first fibres, onto a mould defining the shape of a part of the sail body;
laying a plurality of strips, formed from second fibres, onto a surface of the first fabric such that at least some of the second fibres extend longitudinally along the sail body.

2. A method as claimed in claim 1, wherein the method comprises the further step of:
forming the plurality of strips.

3. A method as claimed in claim 1, wherein one or more of the plurality of strips is formed using a pultrusion or pulwinding process.

4. A method as claimed in claim 1, wherein one or more of the plurality of strips is formed so as to at least partially define a cavity within the sail body.

5. A sail body as claimed in claim 1, wherein one or more of the plurality of strips is formed so that at least one end comprises a taper.

6. A method as claimed in claim 1, wherein each strip of the plurality of strips comprises a pair of profiled edges, each profiled edge shaped to nest or interlock with a profiled edge of an adjacent strip, and the step of laying the plurality of strips onto the surface of the first fabric comprises nestling, or interlocking, a profiled edge of one or more of the plurality of strips against, or into engagement, with a profiled edge of an adjacent strip.

7. A method as claimed in claim 1, wherein the step of laying the plurality of strips onto the surface of the first fabric comprises at least one of:
pre-bonding the strips to a backing scrim;
using one or more rigid or flexible jigs to hold the plurality of strips against the first fabric; and
weaving fibres or light cloth tape between the strips.

8. A method as claimed in claim 1, wherein the step of laying the plurality of strips comprises laying the plurality of strips such that an average width of an area of the first fabric not covered by any strip is less than 30% of a total width of a first skin, each width being measured normal to the strips and the average width being dependent on all areas of the first fabric not covered by any strip.

9. A method as claimed in claim 1, wherein the mould is a female mould and the plurality of strips are laid onto a concave surface of the first fabric.

10. A method as claimed in claim 1, comprising the further steps of:
introducing resin into the first fabric and, optionally, into and/or between the plurality of strips; and
heating the mould to cure the resin.

11. A method as claimed in claim 10, wherein the first fabric, plurality of strips and cured resin form a sail body part for forming the sail body.

12. A method as claimed in claim 1, comprising the further step of:
laying a second fabric, formed from third fibres, onto the plurality of strips.

13. A method as claimed in claim 12, comprising the further steps of:
introducing resin into the first and second fabrics and into and/or between the plurality of strips; and
heating the mould to cure the resin,
wherein the first fabric, plurality of strips, second fabric and cured resin form a sail body part for forming the sail body.

14. A method as claimed in claim 11, wherein one or more of the plurality of strips is formed so as to at least partially define a cavity within the sail body, the method comprising the further step of:
making an aperture extending from a surface of the sail body part to the cavity.

15. A method as claimed in claim 12, wherein the plurality of strips forms a first layer of strips and the method comprises the further step of:
laying one or more additional pluralities of strips onto at least part of the first layer of strips, or the second fabric, to form one or more auxiliary layers of strips.

16. A method as claimed in claim 15, comprising the further step of:
laying an intermediary fabric onto at least part of a laid layer of strips prior to laying an additional layer of strips onto said at least part of the laid layer of strips.

17. A method as claimed in claim 1, comprising the further step of:
joining two or more sail body parts together to form a sail body.

18. A method as claimed in claim 1, comprising the further step of:
attaching one or more circumferential ribs to an inner surface of one or more sail body parts.

19. A method as claimed in claim 1, wherein the wind assisted propulsion device is one of a rotor sail; a wing sail; and a suction sail.

20. A method as claimed in claim 19, wherein the wind assisted propulsion device is a rotor sail and the sail body is a rotor sail body.

21. A method as claimed in claim 20, wherein the mould comprises a substantially semi-cylindrical surface.

22. A sail body for forming part of a wind assisted propulsion device, the sail body comprising a plurality of sail body parts joined together to form the sail body, each sail body part comprising:
a first skin formed from a first fibrous material formed from first fibres; and,
a plurality of strips extending longitudinally along the sail body,
wherein each strip is formed from a second fibrous material formed from second fibres, at least some of which second fibres extend longitudinally along the sail body.

23-38. (canceled)

39. A vessel comprising a wind assisted propulsion device attached to a portion of the vessel, which wind assisted propulsion device comprises a sail body comprising:
a plurality of sail body parts joined together to form the sail body, each sail body part comprising:
a first skin formed from a first fibrous material formed from first fibres; and,
a plurality of strips extending longitudinally along the sail body,
wherein each strip is formed from a second fibrous material formed from second fibres, at least some of which second fibres extend longitudinally along the sail body.
